(19) United States
(12) Patent Application Publication
(10) Pub. No.: US 2018/0126458 A1
(43) Pub. Date: May 10, 2018

(54) Apparatus of Dividing Working Chamber of 3D Printer

(71) Applicant: Hyundai Motor Company, Seoul (KR)

(72) Inventor: Kwang Hoon Choi, Yongin-si (KR)

(21) Appl. No.: 15/495,567

(22) Filed: Apr. 24, 2017

(30) Foreign Application Priority Data
Nov. 10, 2016 (KR) 10-2016-0149282

(51) Int. Cl. B22F 3/105; B29C 67/00; B33Y 10/00; B33Y 30/00; B33Y 50/02

(52) U.S. Cl. CPC B22F 3/1055; B29C 67/0077; B29C 67/0088; B22F 2003/1057; B33Y 30/00; B33Y 50/02; B33Y 10/00

(57) ABSTRACT

An apparatus of a 3D printer includes a working chamber plate that is disposed in a lower portion of a working chamber and is capable of being raised and lowered. A number of subsidiary plates are mounted on the working chamber plate. Each subsidiary plate is capable of being raised and lowered. A controller is configured to control raised and lowered heights of the subsidiary plates. Some of the subsidiary plates can be raised or lowered according to a size of a processed product to be 3D printed in the working chamber thereby adjusting a size of an inner volume of the working chamber.

### CROSS-REFERENCE TO RELATED APPLICATIONS

This application claims under 35 U.S.C. § 119(a) the benefit of priority to Korean Patent Application No. 10-2016-0149282 filed on Nov. 10, 2016, the entire contents of which are incorporated herein by reference.

### TECHNICAL FIELD

The present disclosure relates to an apparatus of dividing a working chamber of a 3D printer.

### BACKGROUND

Recently, in order to manufacture plastic parts for vehicles, a method of manufacturing a part using a 3D printer is applied in place of general methods, such as injection molding, compression molding, etc.

That is, 3D printers were simply used to execute modeling or to manufacture samples before mass production in the past, but recently 3D printers are used to manufacture products, which may be mass-produced in a small quantity batch production manner, due to advance in 3D printer equipment.

3D printing methods may include Fused Deposition Modeling (FDM), in which a molten thermoplastic resin processed as a filament type is injected and thus layers thereof are stacked one by one, a Stereo Lithography Apparatus (SLA) method using a principle in which, a laser beam is radiated onto a photocurable resin and the resin at the beam radiated portion is thermally cured, and a Selective Laser Sintering (SLS) method in which a laser beam is radiated using a functional polymer or metal powder instead of the photocurable resin in the SLA method and the functional polymer or the metal powder is sintered, etc.

Hereinafter, the configuration and operation of a conventional 3D printer using a laser beam will be described.

FIG. 1 is a conceptual view illustrating a conventional 3D printing method using a laser beam, and FIG. 2 is a view schematically illustrating a working chamber of a conventional 3D printer using a laser beam. Here, reference numeral 10 indicates a working chamber and reference numeral 12 indicates a powder chamber in which powder for 3D printing (resin powder or metal powder) is stored.

The powder chamber 12 is a chamber to store a powder material for 3D printing, and a powder chamber plate 12-1, which is raised and lowered by an actuator, is disposed in the lower portion of the powder chamber 12.

Therefore, the powder chamber plate 12-1 is lowered when the inside of the powder chamber 12 is filled with powder, and the powder chamber plate 12-1 is raised to push up the powder when the powder is transferred toward the working chamber 10.

The working chamber 10 is a chamber in which 3D printing is substantially carried out, and a working chamber plate 10-1, which is raised and lowered by an actuator, is disposed in the lower portion of the working chamber 10.

Therefore, the working chamber plate 10-1 is raised to the maximum height when 3D printing is started, the powder from the powder chamber 12 is applied to the working chamber plate 10-1 raised to the maximum height, and, when a laser beam is radiated onto the applied powder, 3D printing is executed in a desired shape.

Here, a coater 14 transferable to left and right is disposed above the working chamber 10 and the powder chamber 12. The coater 14 serves to transfer the powder in the powder chamber 12 to the working chamber 10 and to apply the powder to a target, i.e., a processed product to be 3D printed, disposed in the working chamber 10 to a designated thickness.

Particularly, a laser light source module 20, a lens 22 to condense a laser beam, a beam scanning unit 24 to reflect the laser beam from the lens 22 and then to radiate the reflected laser beam onto the processed product to be 3D printed (in a powdery state), etc. are arranged in parallel at a position spaced apart from an upper part of the working chamber 10.

Here, the laser light source module 20, the lens 22 and the beam scanning unit 24 are attached to a 3D transfer device (not shown in FIG. 1 and, for example, a linear motor and an elevator motor, etc.) which is mounted on a frame of a 3D printer so as to be transferable in the X-axis, Y-axis and Z-axis directions.

Therefore, when the powder in the powder chamber 12 is applied to the working chamber plate 10-1 of the working chamber 10 to a designated thickness by the coater 14, a laser beam is radiated onto the powder corresponding to a region, in which 3D printing is carried out (a region predetermined by 3D coordinate data), in the overall area of the working chamber 10 and the powder is cured, thus manufacturing a desired 3D processing product.

That is, the laser beam from the laser light source module 20 is radiated onto the processed product (in a powdery state) through the lens 22 and the beam scanning unit 24 and, thus, the powder is cured by heat of the laser beam and processing of a desired 3D processed product is started.

Thereafter, manufacture of the desired 3D processed product may be completed by repeating an operation in which the working chamber plate 10-1 is lowered to a predetermined height, an operation in which the coater 14 re-applies the powder in the powder chamber 12 to the 3D processed product (in an incomplete state) on the working chamber plate 10-1 to the designated thickness, and an operation in which the laser beam is again radiated onto the re-applied powder.

After 3D printing is finished, a worker manually moves the powder located at the remaining positions of the inside of the working chamber 10 except for the powder located at the position, where 3D printing is carried out, to an overflow chamber 16 for recycling.

However, the above-described conventional 3D printer has problems as follows.

First, the overall area of the inside of the working chamber needs to be filled with powder regardless of the size of a processed product to be 3D printed and, thus, an excessive amount of the powder is consumed.

That is, although the working chamber has a large volume and the processed product to be 3D printed in the working chamber has a very small size, the inside of the working chamber is needed to be filled with powder up to the height of the processed product and, thus, an unnecessary amount of the powder is wasted.

Second, the coater is transferred throughout the overall area of the working chamber so as to apply the powder, application of the powder by the coater requires long reciprocating distance and time and, thus, productivity is lowered.

That is, since the coater is transferred to a more distant position than a position, where 3D printing is carried out, in the overall area of the working chamber such that the powder is applied to the overall area of the working chamber, application of the powder by the coater requires long reciprocating distance and time and, thus, productivity is lowered.

Third, the powder located at the remaining positions of the inside of the working chamber except for the powder located at the position, where 3D printing is carried out, is manually moved to the overflow chamber for recycling and, thus, it takes a long time to replace the powder with new powder so as to execute the next 3D printing process.

### SUMMARY

The present disclosure relates to an apparatus of dividing a working chamber of a 3D printer. Particular embodiments relate to an apparatus of dividing a working chamber of a 3D printer which divides the working chamber to execute 3D printing into a plurality of spaces so as to shorten a 3D printing time and to reduce consumption of powder, i.e., a 3D printing material.

The present invention has been made in an effort to solve the above-described problems associated with the prior art and provides an apparatus of dividing a working chamber of a 3D printer which may divide the working chamber to execute 3D printing into a plurality of spaces and thus adjust the size of the inner volume of the working chamber according to the size of a processed product to be 3D printed so as to reduce consumption of powder, i.e., a 3D printing material, and to shorten a 3D printing time.

In one aspect, the present invention provides an apparatus of dividing a working chamber of a 3D printer. The apparatus includes a working chamber plate that is disposed in the lower portion of a working chamber and is raised and lowered. A plurality of subsidiary plates are mounted on the working chamber plate and raised and lowered. A controller is configured to control the raised and lowered heights of the subsidiary plates. Some of the subsidiary plates are raised and lowered according to the size of a processed product to be 3D printed in the working chamber and thus the size of the inner volume of the working chamber is adjusted.

In an embodiment, the same number of the subsidiary plates may be arranged in a matrix at the same interval in the horizontal and vertical directions, and the subsidiary plates may be mounted on the working chamber plate so as to be raised and lowered.

In another embodiment, a barrier structure disposed between the subsidiary plates to prevent the powder from leaking may be mounted on the working chamber plate.

In still another embodiment, guide laser devices to confirm leveled heights of the subsidiary plates and the powder with which the inside of the working chamber is filled may be mounted at the upper end of the wall of one side surface of the working chamber.

In yet another embodiment, a subsidiary actuator supported by the working chamber plate may be mounted on the lower surface of each of the subsidiary plates, and the subsidiary actuator may be surrounded by a bellows-type protective cover.

In still yet another embodiment, a forward and backward movement driving unit and a movable plate moving forwards by driving the forward and backward movement driving unit so as to be disposed on some of the subsidiary plates in the lowered state may be mounted at the wall of one side surface of the working chamber.

In a further embodiment, the forward and backward movement driving unit may include a blower motor to supply and suck air, and an expandable and contractible bellows tube installed in a sealed state between the blower motor and the movable plate.

In another further embodiment, if a support to prevent the processed product to be 3D printed in the working chamber from being tilted is required, the controller may execute height control of raising one or more of the subsidiary plates to a height to prevent the processed product from being tilted.

Other aspects and preferred embodiments of the invention are discussed infra.

The above and other features of the invention are discussed infra.

### BRIEF DESCRIPTION OF THE DRAWINGS

The above and other features of the present invention will now be described in detail with reference to certain exemplary embodiments thereof illustrated in the accompanying drawings which are given hereinbelow by way of illustration only, and thus are not limitative of the present invention, and wherein:

FIG. 1 is a conceptual view illustrating a conventional 3D printing method using a laser beam;

FIG. 2 is a view schematically illustrating a working chamber of a conventional 3D printer using a laser beam;

FIGS. 3A and 3B are plan and cross-sectional views illustrating an apparatus of dividing a working chamber of a 3D printer in accordance with one embodiment of the present invention;

FIGS. 4A and 4B are plan and cross-sectional views illustrating the operating state of the apparatus in accordance with one embodiment of the present invention;

FIGS. 5A and 5B are plan and cross-sectional views illustrating an apparatus of dividing a working chamber of a 3D printer in accordance with another embodiment of the present invention;

FIGS. 6A and 6B are plan and cross-sectional views illustrating the operating state of the apparatus in accordance with another embodiment of the present invention;

FIG. 7 is a cross-sectional view exemplarily illustrating a 3D printing process carried out in a working chamber of a conventional 3D printer; and

FIG. 8 is a cross-sectional view exemplarily illustrating a 3D printing process carried out in a working chamber of a 3D printer in accordance with the present invention.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION OF ILLUSTRATIVE EMBODIMENTS

Hereinafter reference will now be made in detail to various embodiments of the present invention, examples of which are illustrated in the accompanying drawings and described below. While the invention will be described in conjunction with exemplary embodiments, it will be understood that the present description is not intended to limit the invention to the exemplary embodiments. On the contrary, the invention is intended to cover not only the exemplary embodiments, but also various alternatives, modifications, equivalents and other embodiments within the spirit and scope of the invention as defined by the appended claims.

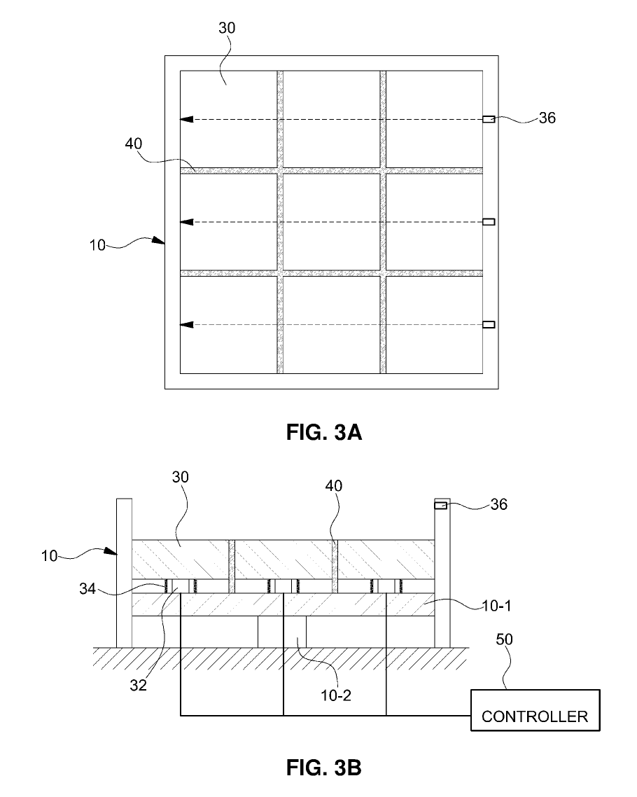

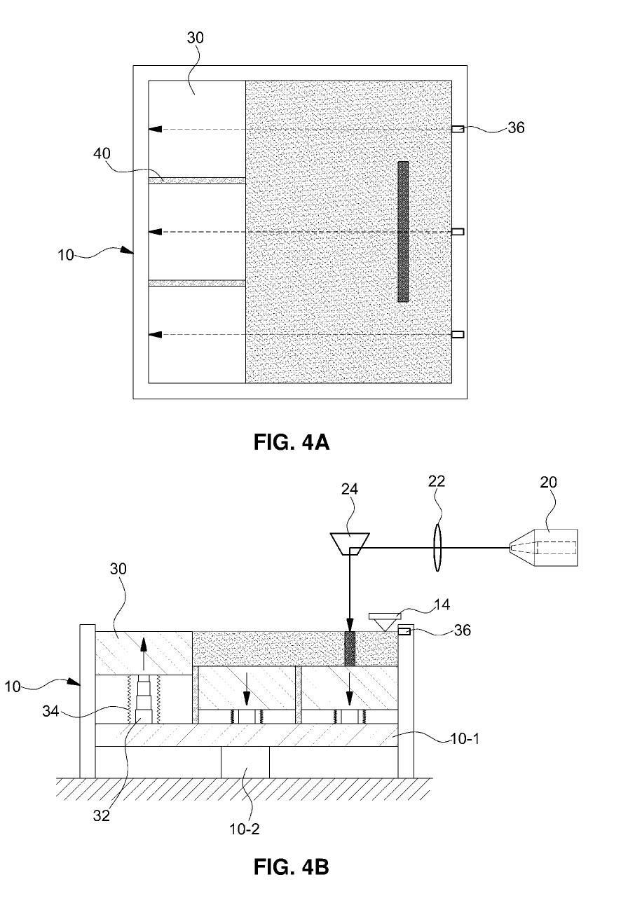

FIGS. 3A and 3B are plan and cross-sectional views illustrating an apparatus of dividing a working chamber of a 3D printer in accordance with one embodiment of the present invention and FIGS. 4A and 4B are plan and cross-sectional views illustrating the operating state of the apparatus in accordance with one embodiment of the present invention.

In FIGS. 3A to 4B, reference numeral 10 indicates a working chamber of a 3D printer.

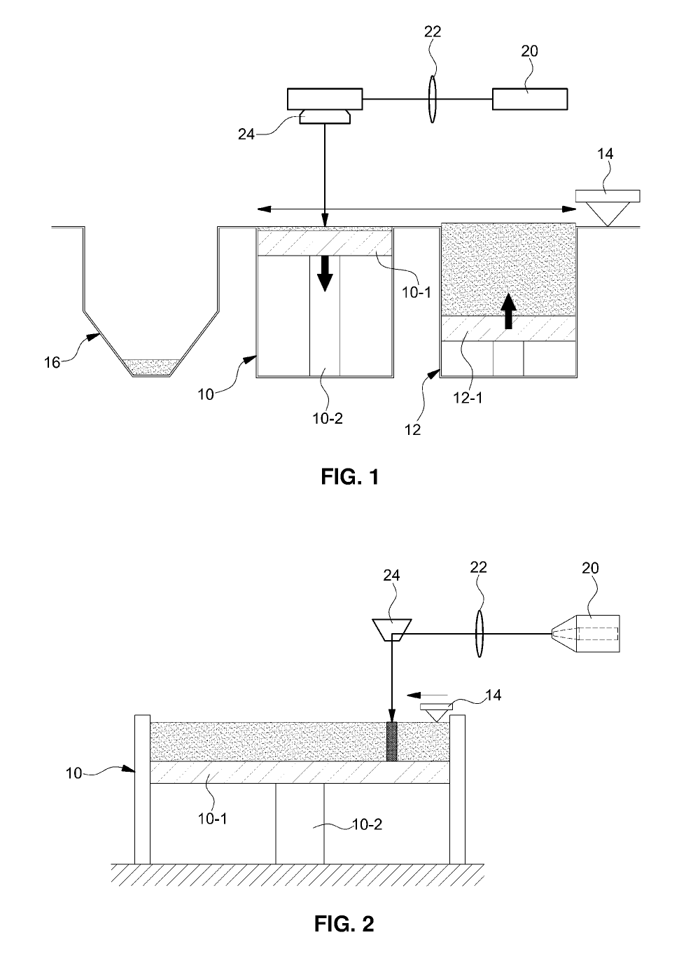

Although not shown in FIGS. 3A to 4B, a powder chamber to store powder (resin powder or metal powder) for 3D printing is disposed right next to the working chamber 10, as described earlier with reference to FIGS. 1 and 2.

The working chamber 10 is a chamber in which 3D printing is substantially carried out, and a working chamber plate 10-1, which is raised and lowered by a main actuator 10-2, is disposed in the lower portion of the working chamber 10.

Here, a plurality of subsidiary plates 30 is disposed on the working chamber plate 10-1 so as to be raised and lowered.

Particularly, the same number of the subsidiary plates 30 is arranged in a matrix at the same interval in the horizontal and vertical directions, and the subsidiary plates 30 are mounted on the working chamber plate 10-1 so as to be raised and lowered.

In order to raise and lower the respective subsidiary plates 30, a subsidiary actuator 32, supported by the working chamber plate 10-1, is mounted on the lower surface of each subsidiary plate 30.

The subsidiary actuators 32 are driving units to raise or lower the respective subsidiary plates 30, and ascend or descend upon receiving a control signal from a controller 50.

Therefore, when the control signal from the controller 50 is transmitted to an encoder included in the subsidiary actuator 32, the subsidiary actuator 32 ascends or descends and may thus adjust the height of the subsidiary plate 30.

Here, since powder, etc. may enter the respective subsidiary actuators 32 and thus cause malfunction of the subsidiary actuators 32, upper and lower ends of bellows-type protective covers 34 are connected respectively to the lower surfaces of the subsidiary plates 30 and the upper surface of the working chamber plate 10-1 and thus surround the circumferences of the subsidiary actuators 32.

Further, a barrier structure 40 disposed between the subsidiary plates 30 to prevent the powder from leaking is mounted on the working chamber plate 10-1.

The barrier structure 40 may be manufactured as an integral structure in which horizontal members and vertical members are arranged in a lattice.

Therefore, since the powder may leak downwards from large gaps between the respective subsidiary plates 30 in a state where the subsidiary plates 30 are arranged in a matrix at the same interval in the horizontal and vertical directions, the barrier structure 40, which is disposed in the gaps between the respective subsidiary plates 30 and attached to the working chamber plate 10-1, serves to prevent leakage of the powder.

Guide laser devices 36 to confirm leveled heights of the subsidiary plates 30 in the raised state and the powder with which the inside of the working chamber 10 is filled are mounted at the upper end of the wall of one side surface of the working chamber 10. Such guide laser devices 36 serve as a kind of pointer which does not generate heat.

Hereinafter, a process of operating the apparatus of dividing the working chamber of the 3D printer in accordance with one embodiment of the present invention will be described.

If a processed product to be 3D printed has a large size, i.e., has a large size to be supported by the overall upper surfaces of all the subsidiary plates 30, all the subsidiary plates 30 are maintained in the lowered state so as to secure the maximum inner volume of the working chamber 10.

On the other hand, if a processed product to be 3D printed has a small size, i.e., has a small size to be supported by some of the subsidiary plates 30, the subsidiary plates 30 supporting the processed product to be 3D printed are sequentially lowered according to a 3D printing stack height and the remaining subsidiary plates 30 are maintained in the raised state so as to reduce the inner volume of the working chamber 10 to be filled with powder.

With reference to FIGS. 4A and 4B, among a total of 9 subsidiary plates 30, the 3 subsidiary plates 30 arranged at one side are maintained in the raised state and the remaining 6 subsidiary plates 30 are gradually lowered in proportion to a sequential stack height of the processed product to be 3D printed (a height gradually increased by repetitive printing), thereby reducing the overall inner volume of the working chamber 10.

Here, the guide laser devices 36 radiate guide laser beams, and the height of the upper surfaces of the subsidiary plates 30 in the raised state and the height of the upper surface of the powder applied onto the subsidiary plates 30 in the lowered state are leveled while visually confirming the guide laser beams. The reason for this is to prevent a coater 14, which is transferring to apply the powder to the inside of the working chamber 10, from being caught by the subsidiary plates 30 in the raised state.

Therefore, the inner space of the working chamber 10 is filled with powder in the powder chamber, wherein the inner space is reduced by maintaining the 3 subsidiary plates 30 arranged at one side in the raised state and lowering the 6 remaining subsidiary plates 30, as exemplarily shown in FIGS. 4A and 4B, and thus a powder consumption rate may be minimized, as compared to a conventional working chamber.

Further, although the inner space of the working chamber 10 that is reduced by lowering the 6 remaining subsidiary plates 30 is filled with powder, the processed product to be 3D printed has a small size and, thus, 3D printing may be easily carried out.

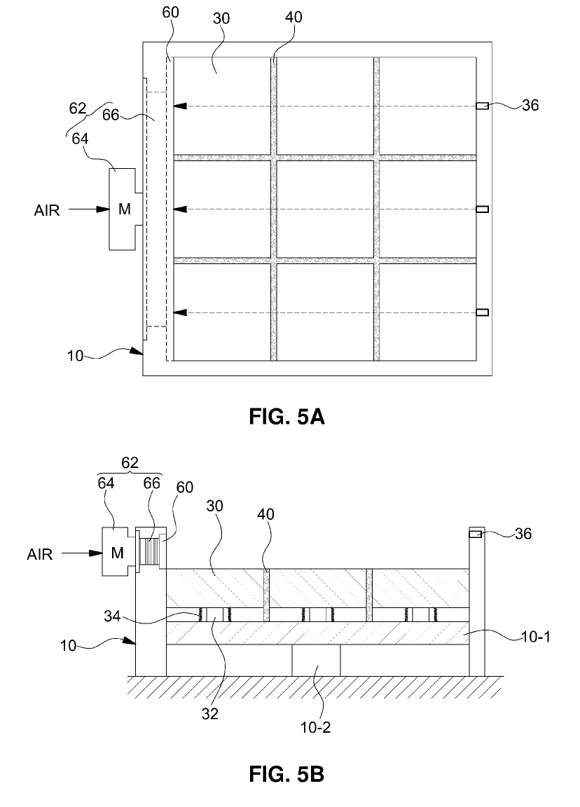

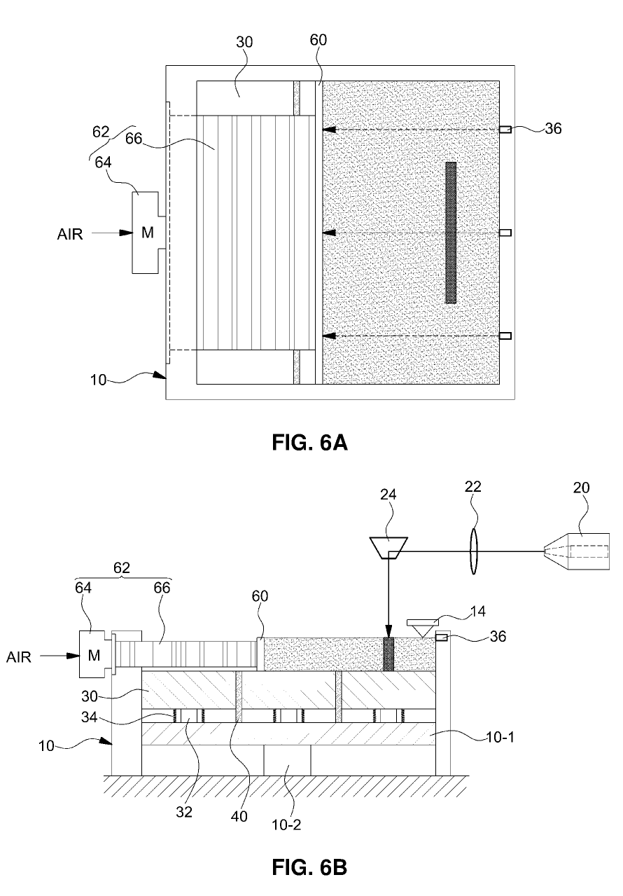

FIGS. 5A and 5B are plan and cross-sectional views illustrating an apparatus of dividing a working chamber of a 3D printer in accordance with another embodiment of the present invention, and FIGS. 6A and 6B are plan and cross-sectional views illustrating the operating state of the apparatus in accordance with another embodiment of the present invention.

The apparatus in accordance with this embodiment is the same as the apparatus in accordance with the former embodiment shown in FIGS. 3A to 4B except that a movable plate 60, which is movable forwards and backwards, is further mounted on subsidiary plates 30.

For this purpose, a forward and backward movement driving unit 62 is mounted at the wall of one side surface of the working chamber 10, and the movable plate 60, which moves forwards and is disposed on selected subsidiary plates 30 of the subsidiary plates 30 in the lowered state, is connected to the forward and backward movement driving unit 62.

The forward and backward movement driving unit 62 may include a blower motor 64 which may supply and suck air, and an expandable and contractible bellows tube 66 which is installed in a sealed state between the blower motor 64 and the movable plate 60.

Therefore, some of the subsidiary plates 30 may be selected and thus raised or lowered to adjust the inner volume of the working chamber 10 and, in this case, the inner volume of the working chamber 10 may be more finely adjusted using the movable plate 60.

For example, as exemplarily shown in FIGS. 6A and 6B, the inner volume of the working chamber 10, i.e., the inner volume of the space on the subsidiary plates 30, may be more finely adjusted by supplying air to the inside of the bellows tube 66 by driving the blower motor 64, moving the movable plate 60 forwards by expansion of the bellows tube 66, and moving forward and then disposing the movable plate 60 at a designated position on the upper surfaces of some subsidiary plates 30 selected from the subsidiary plates 30.

As such, if a processed product to be 3D printed has a small size, the inner volume of the working chamber 10 may be reduced by raising or lowering the subsidiary plates 30 and, further, the inner volume of the working chamber 10 may be more finely reduced using the movable plate 60, thereby greatly reducing consumption of powder with which the powder chamber 12 is filled, as compared to a conventional working chamber.

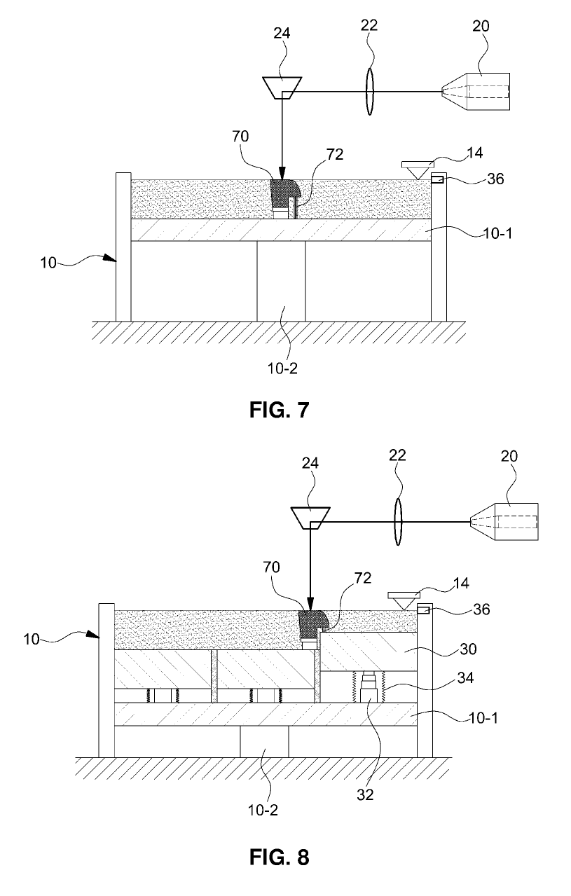

With reference to FIG. 7, when 3D printing is carried out in a conventional working chamber 10, if a target to be 3D printed, i.e., a processed product 70, has a shape, the area of which is increased in the upward direction, and which is provided with a dent formed at one side thereof, the processed product 70 may lean to one side.

Therefore, 3D printing of a separate support 72 (a plurality of thin lines) is carried out at one side portion of the processed product together from the start of 3D printing of the processed product. The support 72 serves as a supporter to prevent the processed product 70 from being tilted and, thus, 3D printing of the processed product 70 may be stably carried out.

Here, since the support 72 is formed integrally with the final processed product 70 after 3D printing has been finished, the support 72 corresponding to an unnecessary element (a part excluded in 3D printing design) is removed by a separate removal process.

As such, the separate process of removing the support 72 from the final processed product 70 after 3D printing has been finished should be further carried out, thus increasing the number of processes necessary to acquire a final product through 3D printing.

In accordance with the present invention, if a support to prevent a processed product 70 to be 3D printed in the working chamber 10 from being tilted is required, the above-described subsidiary plates 30 may serve as the support.

As exemplarily shown in FIG. 8, when the processed product 70 to be 3D printed is printed as a shape leaning to one side, some of the subsidiary plates 30 are raised to support the leaning side of the processed product 70 and, thus, although the length of the support 72 is minimized or the support 72 is omitted, 3D printing of the processed product 70 may be stably carried out until 3D printing ends.

More particularly, the subsidiary actuators 32 ascend upon receiving a control signal from the controller 50 and thus raise the subsidiary plates 30, and the raised subsidiary plates 30 may support the leaning side of the processed product 70 so that the processed product 70 may maintain a stable posture until 3D printing ends.

As is apparent from the above description, an apparatus of dividing a working chamber of a 3D printer in accordance with the present invention may have effects as follows.

First, the apparatus divides the working chamber to execute 3D printing into a plurality of spaces using a plurality of subsidiary plates and, if a processed product to be 3D printed has a small size, raises some subsidiary plates so as to reduce the inner volume of the working chamber, thereby reducing a consumption rate of powder, i.e., a 3D printing material with which the working chamber is filled.

Second, as the inner volume and area of the working chamber may be reduced, the transfer distance of a coater to apply the powder to the inside of the working chamber may be shortened and, thus, a 3D printing time may be shortened.

Third, when the processed product to be 3D printed is printed as a shape leaning to one side, the leaning side of the processed product is supported by some of the subsidiary plates and, thus, 3D printing of the processed product may be stably carried out until 3D printing ends.

In summary, one embodiment apparatus may divide the working chamber to execute 3D printing into a plurality of spaces and thus adjust the size of the inner volume of the working chamber according to the size of a processed product to be 3D printed so as to reduce consumption of powder, i.e., a 3D printing material, and to shorten a 3D printing time.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. An apparatus of a 3D printer, the apparatus comprising:
a working chamber plate disposed in a lower portion of a working chamber, the working chamber plate being capable of being raised and lowered;
a plurality of subsidiary plates mounted on the working chamber plate, each subsidiary plate capable of being independently raised and lowered; and
a controller configured to control heights of the subsidiary plates, wherein some of the subsidiary plates can be raised or lowered according to a size of a processed product to be 3D printed in the working chamber thereby adjusting a size of an inner volume of the working chamber.

2. The apparatus of claim 1, wherein the subsidiary plates are arranged in a matrix.

3. The apparatus of claim 2, wherein the matrix includes the same number of subsidiary plates in a horizontal direction as in a vertical direction.

4. The apparatus of claim 3, wherein each subsidiary plate has the same area taken in a plane of the horizontal and vertical directions.

5. The apparatus of claim 1, further comprising a powder chamber to store powder for 3D printing, the powder chamber adjacent the working chamber.

6. The apparatus of claim 1, further comprising a barrier structure mounted on the working chamber plate between the subsidiary plates.

7. The apparatus of claim 6, wherein the barrier structure is configured to prevent powder from leaking.

8. The apparatus of claim 1, further comprising guide laser devices configured to determine heights of the subsidiary plates.

9. The apparatus of claim 8, wherein the guide laser devices are mounted at an upper end of a wall of one side surface of the working chamber.

10. The apparatus of claim 8, wherein the guide laser devices are further configured to determine leveled heights of powder within the working chamber.

11. The apparatus of claim 1, further comprising a subsidiary actuator supported by the working chamber plate and mounted on a lower surface of each of the subsidiary plates.

12. The apparatus of claim 11, wherein the subsidiary actuator is surrounded by a bellows-type protective cover.

13. The apparatus of claim 1, further comprising a forward and backward movement driving unit and a movable plate mounted at a wall of one side surface of the working chamber so as to be disposed on some of the subsidiary plates in a lowered state, the movable plate configured to be moved by driving the forward and backward movement driving unit.

14. The apparatus of claim 13, wherein the forward and backward movement driving unit includes a blower motor to supply and remove air, and an expandable and contractible bellows tube installed in a sealed state between the blower motor and the movable plate.

15. The apparatus of claim 1, wherein the controller is configured to execute height control of raising one or more of the subsidiary plates to a height to prevent the processed product from being tilted.

16. A method of operating a 3D printer that operates with a working chamber that includes a working chamber plate is disposed in a lower portion of the working chamber and a plurality of subsidiary plates mounted on the working chamber plate, the method comprising:
determining a size of a product to be 3D printed;
adjusting an inner volume of the working chamber by independently setting a height of each subsidiary plate according to the size of the product to be 3D printed; and
3D printing a processed product based upon the product to be 3D printed.

17. The method of claim 16, further comprising using guide laser devices to confirm leveled heights of the subsidiary plates and powder inside of the working chamber is filled.

18. The method of claim 16, further comprising adjusting the inner volume of the working chamber by moving a side wall of the working chamber.

19. The method of claim 16, further comprising executing height control by raising one or more of the subsidiary plates to a height to prevent the processed product from being tilted.
